(19) United States
(12) Patent Application Publication
(10) Pub. No.: US 2009/0134118 A1
(43) Pub. Date: May 28, 2009

(54) Method of manufacturing printed circuit board

(75) Inventors: Dong-Jin Park, Seongnam-si (KR); Seung-Hyun Jung, Suwon-si (KR); Seung-Chul Kim, Cheongju-si (KR); Sooh-Jin Cho, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/213,699

(22) Filed: Jun. 23, 2008

(30) Foreign Application Priority Data
Nov. 26, 2007 (KR) 10-2007-0121080

(51) Int. Cl. H01B 13/00

(52) U.S. Cl. 216/13

(57) ABSTRACT

A method of manufacturing a printed circuit board is disclosed. The method may include: stacking a cover layer over a copper foil, for a copper clad laminate that includes the copper foil stacked over one side of an insulation layer; forming an intaglio groove by removing portions of the cover layer and the copper clad laminate; stacking a seed layer over a surface of the intaglio groove and the cover layer; removing a portion of the seed layer stacked over the cover layer, by removing a portion of the cover layer; forming a plating layer, by plating an inside of the intaglio groove; and removing the remaining cover layer and the copper foil.

### CROSS-REFERENCE TO RELATED APPLICATIONS

This application claims the benefit of Korean Patent Application No. 10-2007-0121080 filed with the Korean Intellectual Property Office on Nov. 26, 2007, the disclosure of which is incorporated herein by reference in its entirety.

### BACKGROUND

1. Technical Field

The present invention relates to a method of manufacturing a printed circuit board having intaglio circuit patterns.

2. Description of the Related Art

With developments in electronic components, fine-line circuit wiring is being employed, in order to provide higher densities in the printed circuit board. This, however, can result in lower adhesion between the metal circuit lines and the insulation, which may cause problems such as the circuit lines being peeled off from the insulation. To improve this, a technique is under development, which includes processing an intaglio groove in the insulation and then filling the groove with metal by a plating process.

The filling of a metal by plating into an intaglio groove having a small width may not pose serious problems even when existing chemicals and processes are employed, but in cases where the width is large, such as the case illustrated in FIG. 1, it can be difficult to obtain a uniform plating thickness using existing techniques, compared to the cases for narrow intaglio grooves. Thus, it may be difficult to obtain a faultless wide circuit pattern 112 without employing a separate leveling process. When an etching process is applied to a plated circuit pattern 112, the inner portion of the intaglio groove can become uncovered, as illustrated in the drawing on the right in FIG. 1.

### SUMMARY

One aspect of the invention provides a method of forming circuit patterns in a simple manner without using a photoresist.

Another aspect of the invention provides a method of manufacturing a printed circuit board. The method includes: stacking a cover layer over a copper foil, for a copper clad laminate that includes the copper foil stacked over one side of an insulation layer; forming an intaglio groove, by removing portions of the cover layer and the copper clad laminate; stacking a seed layer over a surface of the intaglio groove and the cover layer; removing a portion of the seed layer stacked over the cover layer, by removing a portion of the cover layer; forming a plating layer, by plating an inside of the intaglio groove; and removing the remaining cover layer and the copper foil.

The operation of removing the remaining cover layer and the copper foil may include removing the cover layer and the copper foil by grinding.

The operation of removing the remaining cover layer and the copper foil may also include physically stripping the cover layer and removing the copper foil by etching.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a cross-sectional view of a printed circuit board according to the related art.

FIG. 2 is a flowchart for a method of manufacturing a printed circuit board according to an embodiment of the invention.

FIG. 3, FIG. 4, FIG. 5, FIG. 6, FIG. 7, and FIG. 8 are drawings representing a process flow diagram for a method of manufacturing a printed circuit board according to an embodiment of the invention.

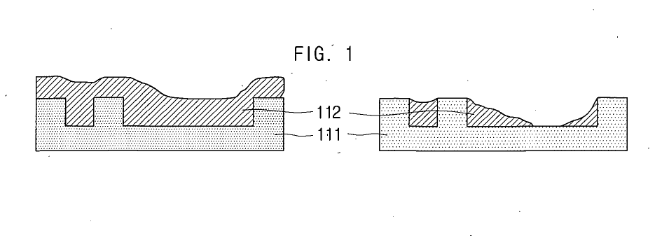

### DETAILED DESCRIPTION

The method of manufacturing a printed circuit board according to certain embodiments of the invention will be described below in more detail with reference to the accompanying drawings. Those components that are the same or are in correspondence are rendered the same reference numeral regardless of the figure number, and redundant explanations are omitted.

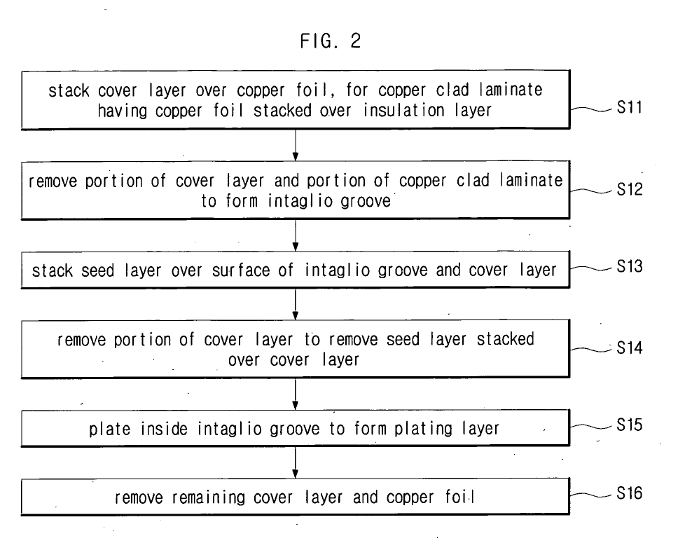

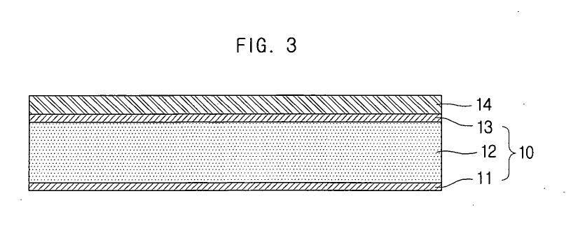

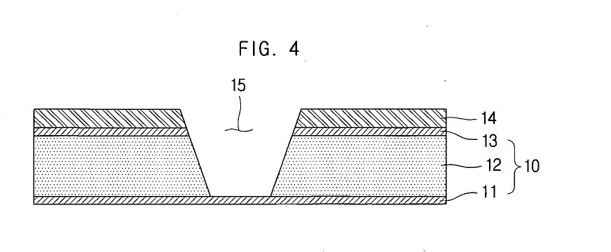

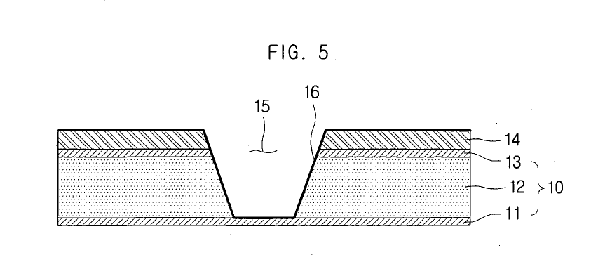

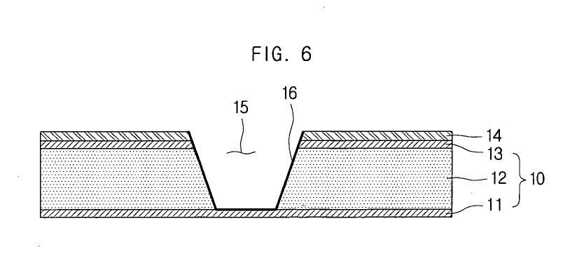

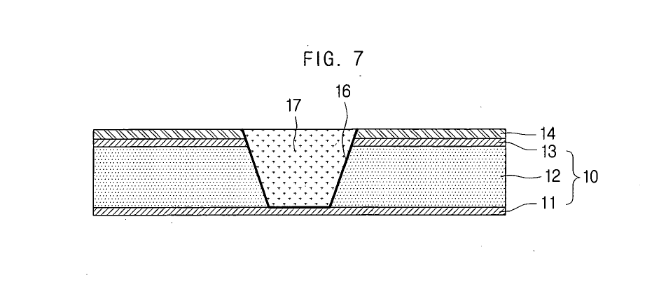

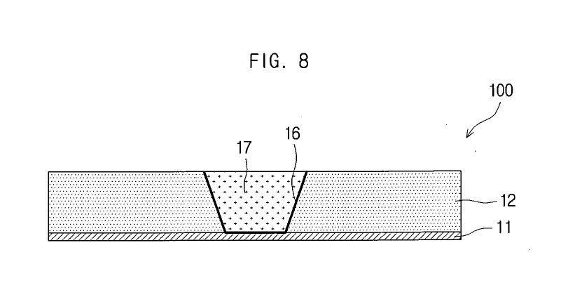

FIG. 2 is a flowchart for a method of manufacturing a printed circuit board according to an embodiment of the invention, while FIG. 3 through FIG. 8 are drawings representing a process flow diagram for a method of manufacturing a printed circuit board according to an embodiment of the invention. In FIGS. 3 to 8, there are illustrated a copper clad laminate 10, copper foils 11, 13, an insulation layer 12, a cover layer 14, an intaglio groove 15, a seed layer 16, and a plating layer 17.

Operation S11 may include, for a copper clad laminate in which a copper foil is stacked over one side of an insulation layer, stacking a cover layer over the copper foil. FIG. 3 illustrates an example of a corresponding process.

The copper clad laminate 10 may have the form of copper foils 11, 13 stacked over both sides of an insulation layer 12, and is an electrical material commonly used in printed circuit boards. It is possible to use a copper clad laminate that has a copper foil stacked only on one side.

The cover layer 14 may be stacked over one side of the copper foil 13. The cover layer 14 can be made from an insulating material.

Operation S12 may include removing portions of the cover layer and portions of the copper clad laminate to form an intaglio groove, where FIG. 4 illustrates an example of a corresponding process.

The intaglio groove 15 may be formed, as illustrated in FIG. 4, using a laser drill. When the inside of the intaglio groove 15 is filled by plating, this will be provided as a circuit pattern. As such, the intaglio groove 15 may be formed in consideration of where the circuit pattern, as well as the pads, etc., is to be placed. Of course, methods known to the public other than laser drilling may also be used.

Operation S13 may include stacking a seed layer over the cover layer and the intaglio groove, where FIG. 5 illustrates an example of a corresponding process.

The seed layer 16 may be formed by electroless plating. Because the intaglio groove 15 and the cover layer 14 may be exposed during the electroless plating, the seed layer 16 may also be stacked over the cover layer 14, which is not directly involved in forming the circuits. Here, the seed layer 16 may be formed by electroless plating performed inside a plating bath.

Operation S14 may include removing a portion of the cover layer to remove the seed layer stacked over the cover layer. FIG. 6 illustrates an example of a corresponding process. A particular thickness of the cover layer 14 may be removed by grinding. When a portion of the cover layer 14 is removed, the seed layer 16 stacked over the cover layer 14 may also be removed.

Operation S15 may include plating inside the intaglio groove to form a plating layer, where FIG. 7 illustrates an example of a corresponding process. By performing electroplating, a plating treatment may be applied over the seed layer 16 remaining inside the intaglio groove 15. As a result, the intaglio groove 15 may be filled with the plating layer 17. Here, the copper foils 11, 13 may be used as lead wires for the plating.

The upper surface of the cover layer 14, on which there is no seed layer 16, may not be plated.

Operation S16 may include removing the remaining cover layer and copper foil, where FIG. 8 illustrates an example of a corresponding process.

The cover layer 14 and the copper foil 13 may be removed at the same time by grinding. In an alternative method, the cover layer 14 may be physically stripped, after which the copper foil 13 may be removed by etching. To “physically strip” the cover layer means that the cover layer 14 may be removed by applying physical force. As a result, a printed circuit board 100 may be completed as illustrated in FIG. 8. The plating layer 17 may serve as the circuit pattern.

According to certain aspects of the invention as set forth above, a cover layer may be used to selectively plate only the portions where plating is desired. Consequently, a printed circuit board can be manufactured without using a photoresist.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A method of manufacturing a printed circuit board, the method comprising:
stacking a cover layer over a copper foil, the copper foil stacked over one side of an insulation layer to form a part of a copper clad laminate;
forming an intaglio groove by removing a portion of the cover layer and a portion of the copper clad laminate;
stacking a seed layer over a surface of the intaglio groove and the cover layer;
removing a portion of the seed layer stacked over the cover layer by removing a portion of the cover layer;
forming a plating layer by plating an inside of the intaglio groove; and
removing the remaining cover layer and the copper foil.

2. The method of claim 1, wherein the removing of the remaining cover layer and the copper foil comprises removing the cover layer and the copper foil by grinding.

3. The method of claim 1, wherein the removing of the remaining cover layer and the copper foil comprises physically stripping the cover layer and removing the copper foil by etching.
